(19) United States
(12) Patent Application Publication
(10) Pub. No.: US 2015/0339550 A1
(43) Pub. Date: Nov. 26, 2015

(54) IMAGE PROCESSING APPARATUS, PRINT INFORMATION GENERATING APPARATUS, IMAGE FORMING APPARATUS, IMAGE FORMING SYSTEM, IMAGE PROCESSING METHOD, PRINT INFORMATION GENERATING METHOD, AND NON-TRANSITORY COMPUTER READABLE MEDIUM

(71) Applicant: FUJI XEROX CO., LTD., Tokyo (JP)

(72) Inventors: Keiji ISHIGURO, Kanagawa (JP); Masashi MURAKAMI, Kanagawa (JP); Atsuo MATSUNAGA, Kanagawa (JP); Atsuhiro ITO, Kanagawa (JP); Masayuki KUDO, Kanagawa (JP)

(21) Appl. No.: 14/521,916

(22) Filed: Oct. 23, 2014

(30) Foreign Application Priority Data
May 26, 2014 (JP) 2014-108479

(51) Int. Cl. G06K 15/02; G06F 3/12

(52) U.S. Cl. CPC G06K 15/1823; G06K 15/1807; G06K 15/1836; G06K 15/1868; G06F 3/1275; G06F 3/124

(57) ABSTRACT

An image processing apparatus includes a print information acquisition unit that acquires a plurality of pieces of print information of each print job to be performed on an image forming unit configured to form an image on a recording material, the plurality of pieces of print information divided by a predetermined number of parallel processes and arranged in ascending or descending discrete page order, a command analyzing unit that command-analyzes the acquired print information, a rasterizing unit that rasterizes the command-analyzed print information to generate raster data, and a concatenating unit that concatinates the generated raster data in a consecutive page order. The print image acquisition unit, the command analyzing unit, and the rasterizing unit perform parallel processes thereof on the print information.

### CROSS-REFERENCE TO RELATED APPLICATIONS

This application is based on and claims priority under 35 USC 119 from Japanese Patent Application No. 2014-108479 filed May 26, 2014.

### BACKGROUND

1. Technical Field

The present invention relates to an image processing apparatus, a print information generating apparatus, an image forming apparatus, an image forming system, an image processing method, a print information generating method, and a non-transitory computer readable medium.

2. Summary

According to an aspect of the invention, an image processing apparatus is provided. The image processing apparatus includes a print information acquisition unit that acquires a plurality of pieces of print information of each print job to be performed on an image forming unit configured to form an image on a recording material, the plurality of pieces of print information divided by a predetermined number of parallel processes and arranged in ascending or descending discrete page order, a command analyzing unit that command-analyzes the acquired print information, a rasterizing unit that rasterizes the command-analyzed print information to generate raster data, and a concatenating unit that concatinates the generated raster data in a consecutive page order. The print image acquisition unit, the command analyzing unit, and the rasterizing unit perform parallel processes thereof on the print information.

### BRIEF DESCRIPTION OF THE DRAWINGS

Exemplary embodiments of the present invention will be described in detail based on the following figures, wherein:

FIG. 1 illustrates a functional configuration of an image forming system of an exemplary embodiment;

FIG. 2 illustrates a hardware configuration of a print information generating apparatus;

FIG. 3 illustrates a hardware configuration of an image forming apparatus;

FIG. 4 is a block diagram illustrating a functional configuration of the print information generating apparatus;

FIG. 5A through FIG. 5D illustrate examples of divided print data;

FIG. 6 is a block diagram illustrating a functional configuration of a controller of the image forming apparatus;

FIG. 7 is a flowchart illustrating an operation of an image forming system of the exemplary embodiment;

FIG. 8 illustrates rendering evaluation information; and

FIG. 9A and FIG. 9B illustrate how differently raster data is generated depending on whether print data is divided in discrete or consecutive order.

### DETAILED DESCRIPTION

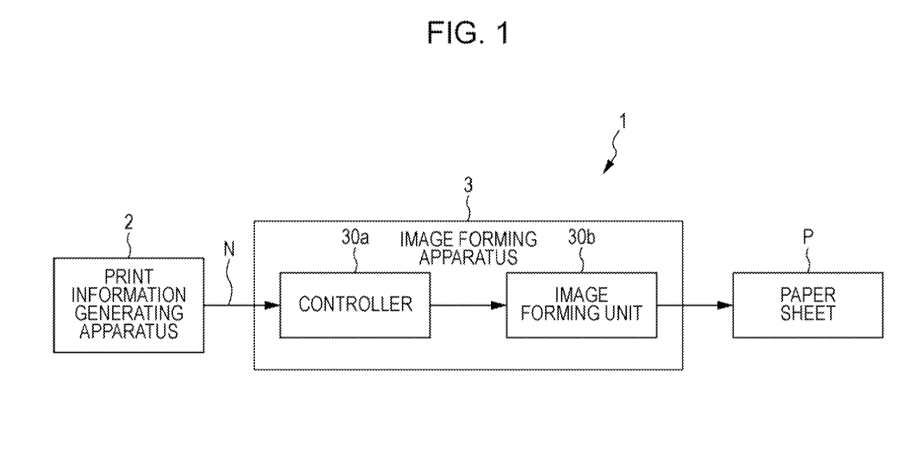

FIG. 1 illustrates a functional configuration of an image forming system 1 of an exemplary embodiment.

The image forming system 1 includes a print information generating apparatus 2 configured to generate print information (print data), and an image forming apparatus 3 configured to print an image by forming the image on a recording material, such as a paper sheet. The print information generating apparatus 2 and the image forming apparatus 3 are connected via a network N. The print data generated by the print information generating apparatus 2 is transmitted to the image forming apparatus 3 via the network N. The network N may be a local area network (LAN) or a wide area network (WAN).

FIG. 1 illustrates a single print information generating apparatus 2 and a single image forming apparatus 3. Alternatively, multiple print information generating apparatuses 2 and multiple image forming apparatuses 3 may be employed.

As described in detail below, the print information generating apparatus 2 is a computer that requests the image forming apparatus 3 to print. The print information generating apparatus 2 generates a print job as a print request unit to the image forming apparatus 3, and the image forming apparatus 3 prints on a per print job basis. The print information generating apparatus 2 may be a personal computer (PC), for example. The print information generating apparatus 2 functions as a terminal apparatus or a printer serve in the image forming system 1.

The image forming apparatus 3 is a printer, for example, and includes a controller 30a and an image forming unit 30b.

As described in detail below, the controller 30a is an example of an image processor (image processing apparatus) configured to generate raster data for use in the image forming unit 30b. The controller 30a processes print data so that the print data is used on the image forming unit 30b, and controls the operation of the image forming unit 30b.

The image forming unit 30b is a print mechanism configured to form an image on a paper sheet P and forms the image on the paper sheet P using at least a type of color material. The image forming unit 30b in the exemplary embodiment is based on an electrophotographic system. For example, a photoconductor drum is uniformly charged, and is then exposed to light that is controlled in accordance with the print data. An electrostatic latent image is thus formed on the photoconductor drum. A developing device visualizes the electrostatic latent image into a toner image of color material. The toner image is then transferred to a paper sheet P. A fixing device then applies heat and pressure to the tone image to fix the toner image onto the paper sheet P.

The image forming unit 30b is not limited to such a system. The image forming unit 30b may be based on an ink-jet system. Ink may be used as color material, and ink is ejected onto the paper sheet P to form an image on the paper sheet P.

Upon printing the image on the paper sheet P, the image forming unit 30b discharges the paper sheet P as printed matter outside the image forming apparatus 3.

If the color image is formed on the electrophotographic system or the ink-jet system, the color materials include those of four colors of yellow (Y), magenta (M), cyan (C), and black (K).

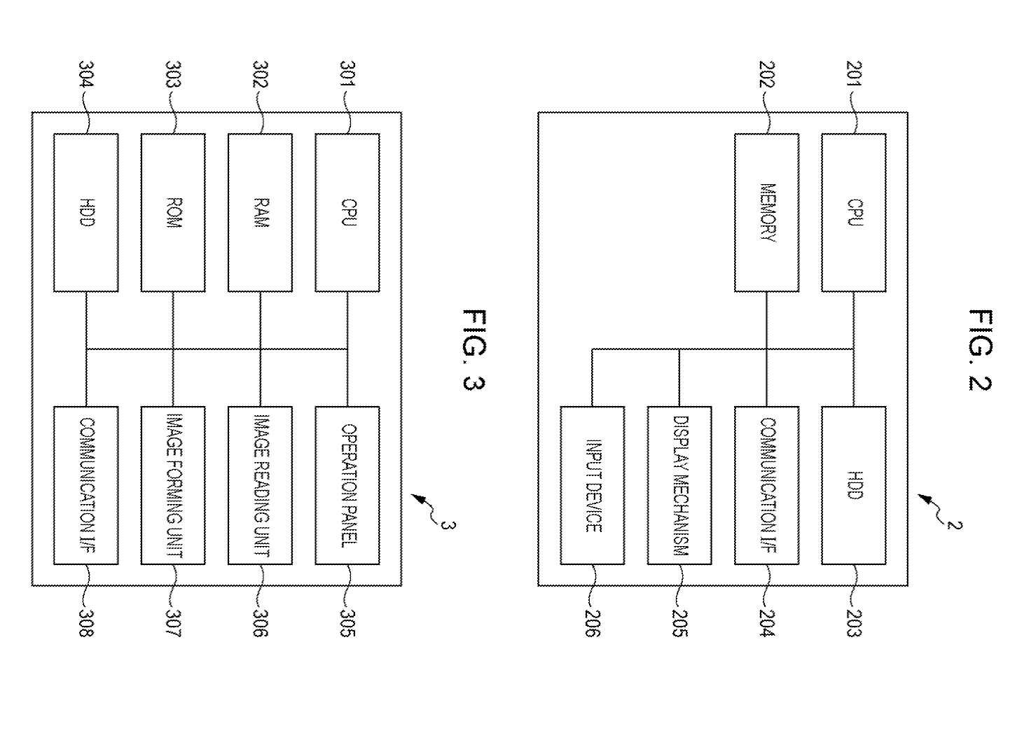

FIG. 2 illustrates a hardware configuration of the print information generating apparatus 2.

As illustrated in FIG. 2, the print information generating apparatus 2 includes a central processing unit (CPU) 201, and a memory 202 and a hard disk drive (HDD) 203 as memory devices. The CPU 201 executes a variety of programs including an operating system (OS), and an application program. The memory 202 stores the variety of programs and data for use in the execution of the programs. The HDD 203 stores data input to the variety of programs and data output from the variety of programs.

The print information generating apparatus 2 further includes a communication interface (I/F) 204 configured to communicate with the outside, a display mechanism 205, including a video memory, and a display, configured to display an image, and an input device 206, such as a keyboard and a mouse.

FIG. 3 illustrates a hardware configuration of the image forming apparatus 3.

As illustrated in FIG. 3, the image forming apparatus 3 includes a CPU 301, a random-access memory (RAM) 302, a read-only memory (ROM) 303, an HDD 304, an operation panel 305, an image reading unit 306, an image forming unit 307, and a communication interface (I/F) 308.

The CPU 301 loads the variety of programs from the ROM 303 or the like to the RAM 302 and executes the programs in order to implement functions described below.

The RAM 302 serves as a working memory of the CPU 301. The ROM 303 stores the variety of programs, including an application program to be executed by the CPU 301.

The HDD 304 stores image data read by the image reading unit 306 and print data used by the image forming unit 307 in image formation.

The operation panel 305 is a touchpanel, for example, and displays a variety of information and receives an operational input from a user.

The image reading unit 306 reads an image recorded on a recoding medium, such as a paper sheet. For example, the image reading unit 306 is a scanner, and is based on a charge-coupled device (CCD) system or a contact image sensor (CIS) system. In the CCD system, a document is irradiated with a light beam, and a light beam reflected from the document is then collected via a lens. In the CIS system, a document is irradiated with a light beam from a light emitting diode (LED), and a light beam reflected from the document is received by a CIS sensor.

The image forming unit 307 corresponds to the image forming unit 30b, and forms an image on the paper sheet P.

The communication I/F 308 exchanges a variety of information with another apparatus, such as the print information generating apparatus 2, via the network N.

In order for the image forming unit 30b in the image forming apparatus 3 to form an image, the controller 30a rasterizes the print data into binary raster data or multi-level raster data.

The rasterizing process typically takes a longer process time, and becomes a bottleneck in an effort to increase a printing speed of the image forming apparatus 3.

A first related art technique available to solve this problem is to prepare multiple image forming apparatuses 3. A period of time each image forming apparatus 3 takes to process a print job from the print information generating apparatus 2 is accounted for and the idling state of each image forming apparatus 3 is also checked. The printing speed is generally increased by distributing the print jobs among the image forming apparatuses 3.

With this technique, however, the process time of each print job is not reduced. The printed matter is discharged from locations different from print job to print job. The image forming apparatuses 3 are not necessarily located close to each other. This inconveniences the users when they collect the printed matter.

A second related art technique available to solve the problem is to rasterize multiple print jobs in parallel.

With the second related art technique, however, the process time is difficult to reduce when a large single print job is processed.

In a third related art technique available to solve the problem, the image forming apparatus 3 includes a processor system to parallel process the print jobs in the rasterization operation only in order to achieve high-speed rasterization.

With the third related art technique, however, a command analysis to be performed prior to the rasterization is a single process, and typically becomes a bottleneck in an effort to achieve high-speed printing. The raster data having undergone the rasterization is written on the same page buffer and thus incurs a large overhead.

The problem is controlled in the exemplary embodiment by constructing the print information generating apparatus 2 and the controller 30a in the image forming apparatus 3 as described below.

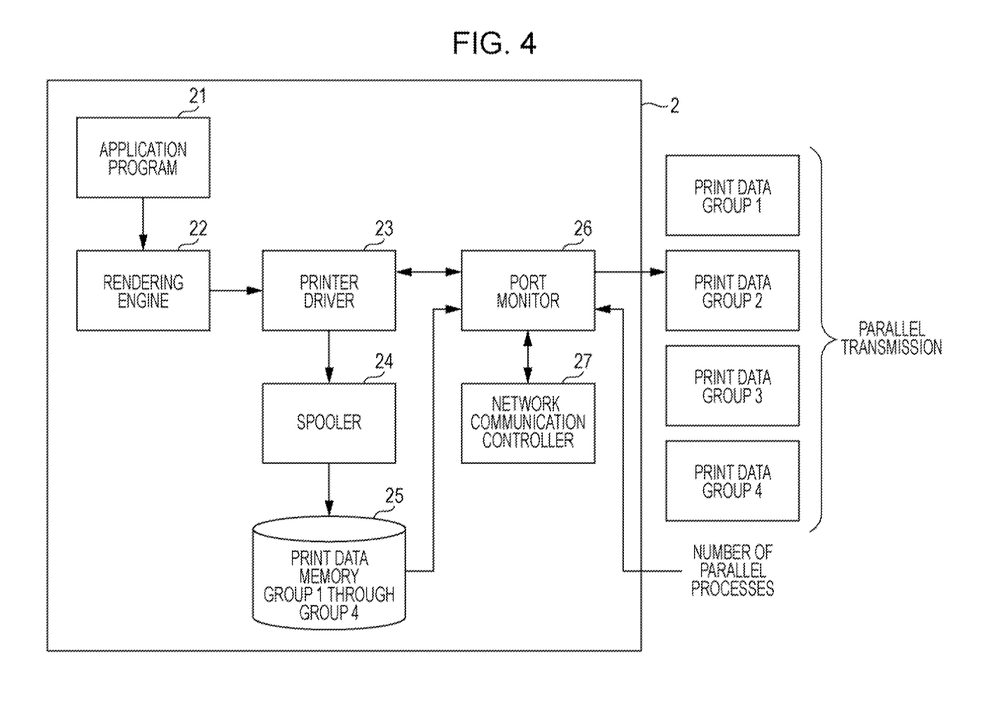

FIG. 4 is a block diagram illustrating a functional configuration of the print information generating apparatus 2.

As illustrated in FIG. 4, the print information generating apparatus 2 includes an application program 21, a rendering engine 22, a printer driver 23, a spooler 24, a printer data memory 25, a port monitor 26, and a network communication controller 27.

The application program 21 performs a variety of processes including word processing, spreadsheet, and editing and processing of an image. The application program 21 generates the print data to be printed on the image forming apparatus 3.

The rendering engine 22 is one function of the OS, and is also referred to as graphic device interface (GDI). The rendering engine 22 performs a graphic process, and is responsible for connecting the application program 21 to the printer driver 23. The rendering engine 22 converts the print data output from the application program 21 into data in a processable form by the printer driver 23 and transfers the resulting data to the printer driver 23.

The printer driver 23 is an example of the print information generating unit and is a program to control the image forming apparatus 3. The printer driver 23 helps the OS to control the image forming apparatus 3, and is typically incorporated into the OS and acts as part of the function of the OS. The printer driver 23 acquires, from the user, print attribute information (information related to size/type/direction of a paper sheet, and simplex printing/duplex printing, and the number of prints). The display mechanism 205 (see FIG. 2) displays a window that receives the print attribute information, and the user inputs the print attribute information using the display mechanism 206 (see FIG. 2). The print attribute information is thus acquired. The printer driver 23 converts the print data into page description language (PDL) data.

In the exemplary embodiment, the printer driver 23 generates multiple pieces of print data that are constructed in ascending or descending discrete page order, and divided by the number of parallel processes equal to the number of parallel processes performed by the image forming apparatus 3.

The “number of parallel processes” is the number of processes executable by the controller 30a in the image forming apparatus 3, and is described more in detail below. The term “discrete” refers to the page numbers of the print data are nonconsecutive rather than consecutive. The term “ascending or descending page order” refers to an ascending page order or a descending page order.

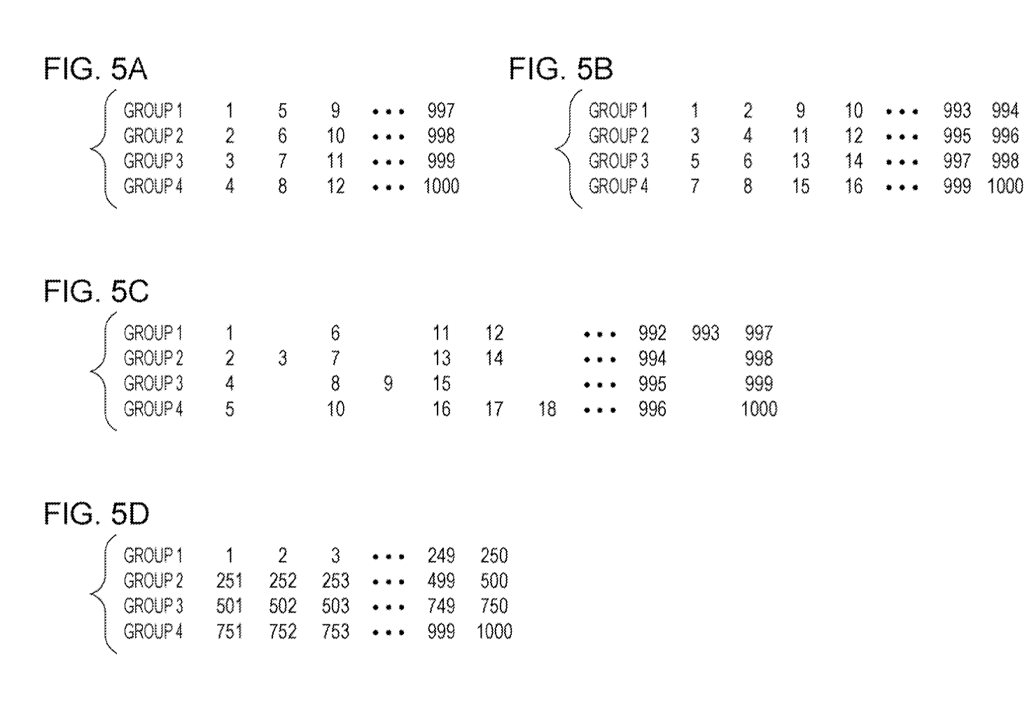

FIG. 5A through FIG. 5D illustrate examples of divided print data.

Referring to FIG. 5A through FIG. 5D, the number of parallel processes is 4. In this case, the print data is divided by 4. The four pieces of print data are illustrated as “group 1”, “group 2”, “group 3”, and “group 4”, and page numbers contained in the group 1 through group 4 are illustrated. The total page count is 1000 pages, and a given page number may take any value within a range from 1 to 1000.

FIG. 5A through FIG. 5C illustrate that divided printed data are discrete.

Referring to FIG. 5A, page 1 through page 4 are respectively allocated to the group 1 through the group 4. Page 5 through page 8 are respectively allocated to the group 1 through the group 4, and this operation is repeated thereafter. The print data is thus divided by 4. More specifically, the pages are allocated in sequence with one page to respective group thereof so that the pages are divided into the four groups.

In the group 1, page order is 1, 5, 9, . . . , and 997 with no consecutive portion arising, and thus the page order is discrete. The page order is ascending page order. The same is true of the group 2 through the group 4 in terms of the page order characteristics.

Referring to FIG. 5B, page 1 and page 2 are allocated to the group 1, page 3 and page 4 allocated to the group 2, page 5 and page 6 are allocated to the group 3, and page 7 and page 8 are allocated to the group 4. By repeating this rule thereafter, the print data is divided into four groups of print data. More specifically, the allocation of two pages to respective groups at a time is repeated to divide the print data into the four groups of print data.

In the group 1, the page order is 1, 2, 9, 10, . . . , 993, and 994. The pages are consecutive only in some portions, and generally discrete. The page order may be considered to be generally discrete. The page order is ascending order. The same is true of the group 2 through the group 4 in terms of the page order characteristics.

Referring to FIG. 5C, pages 1, 6, 11, 12, . . . , 992, 993, and 997 are allocated to the group 1. Pages 2, 3, 7, 13, 14, . . . , 994, and 998 are allocated to the group 2. Pages 4, 8, 9, 15, . . . , 995, and 999 are allocated to the group 3. Pages 5, 10, 16, 17, 18, . . . , 996, and 1000 are allocated to the group 4. The print data is thus divided into the four groups.

In the group 1, the page order is only partially consecutive and is determined to be generally discrete. The page order is ascending order. The same is true of the group 2 through the group 4 in terms of the page order characteristics.

In FIG. 5A and FIG. 5B, the four groups are equal in the total page count, but in FIG. 5C, the four groups are not necessarily equal in the total page count.

FIG. 5D illustrates that the page order of the divided print data is not discrete.

Referring to FIG. 5D, pages 1 through 250 are allocated to the group 1. Similarly, pages 251 through 500 are allocated to the group 2, pages 501 through pages 750 are allocated to the group 3, and pages 751 through 1000 are allocated to the group 4. In this applied rule, the print data is divided into the four groups. In the group 1, the page order is 1, 2, 3, . . . , 249, and 250, and there is no discrete page order portion with all the pages appearing consecutively. The page order is consecutive and not discrete. The same is true of the group 2 through the group 4 in terms of the page order characteristics.

Returning to the description of FIG. 4, the spooler 24 arranges the print data divided by the number of parallel processes into a spool file, and accumulates (spools) the spool file on the printer data memory 25 for temporal storage. In this case, attribute information, such as identification (ID) of the print job or a spool number (a group number of the group 1 through the group 4 in the example of FIG. 5) is attached to the spool file.

The port monitor 26 is an example of a transmitting unit, and polls the image forming apparatus 3 to enquire the progress of printing at predetermined time intervals, and receives a progress report about the progress of printing. If the image forming apparatus 3 is ready for printing, the port monitor 26 acquires the divided print data from the printer data memory 25, and transmits the divided print data to the image forming apparatus 3. The port monitor 26 also transmits the generated multiple pieces of print data to the image forming apparatus 3 in parallel.

The network communication controller 27 controls transmission of the print data transmitted from the port monitor 26. In the exemplary embodiment, the network communication controller 27 performs control to transmit the divided pieces of print data in parallel. The attribute information such as the ID of the print job and the group number discussed with reference to FIG. 5A through FIG. 5D may also be transmitted.

In the parallel transmission, multiple communication lines may be used. The parallel transmission is not limited to a transmission method of transmitting the print data fully in parallel. For example, the parallel transmission may be performed using packet communication. In the packet communication, each divided piece of print information is further segmented into data packets, and the data packets are successively transmitted via a single communication line.

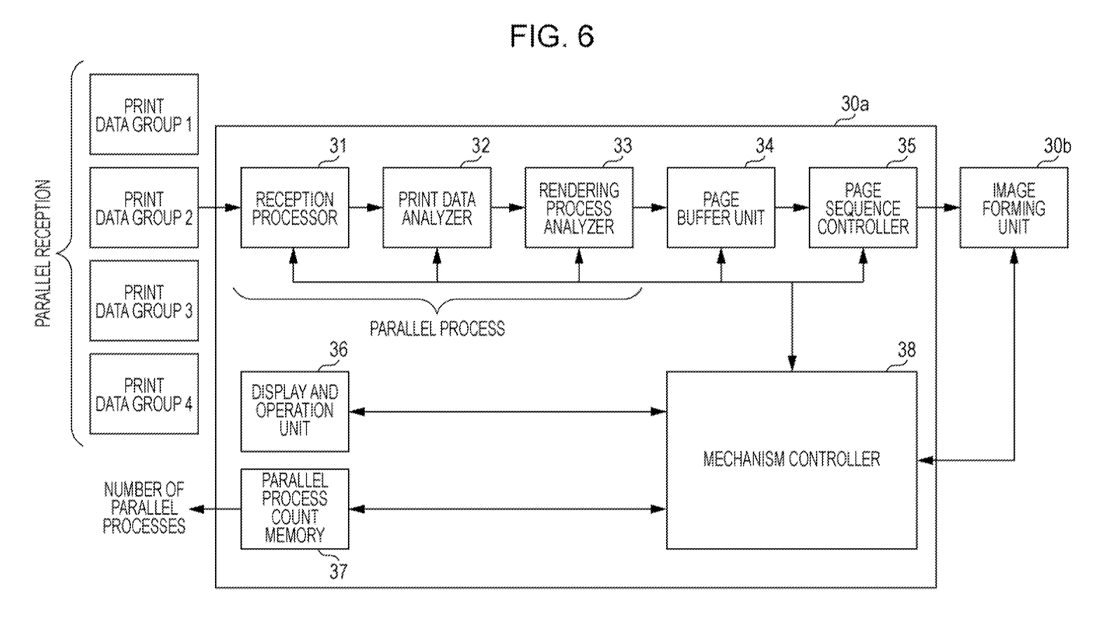

FIG. 6 is a block diagram illustrating a functional configuration of the controller 30a in the image forming apparatus 3.

As illustrated in FIG. 6, the controller 30a includes a reception processor 31, a print data analyzer 32, a rendering process analyzer 33, a page buffer unit 34, a page sequence controller 35, a display and operation unit 36, a parallel process count memory 37, and a mechanism controller 38.

The reception processor 31 receives the print data transmitted from the port monitor 26 in the print information generating apparatus 2. The reception processor 31 functions as a print information acquisition unit configured to acquire multiple pieces of print data respectively divided for print jobs. The print data received by the reception processor 31 may be temporarily stored on a memory.

The print data analyzer 32 is an example of a command analyzer, and command-analyzes the acquired multiple pieces of print data. Since the print data is converted into PDL data, the print data analyzer 32 analyzes the PDL data, thereby expanding the PDL data into multiple simple drawings including lines, triangles, and rectangles (drawing primitives).

The rendering process analyzer 33 converts the drawing primitives into raster data on each pixel on a per page basis to obtain a raster image. The raster data is temporarily stored on the page buffer unit 34. The rendering process analyzer 33 functions as a rasterizing unit configured to rasterize the drawing primitives to generate the raster data.

Operations of the reception processor 31, the print data analyzer 32, and the rendering process analyzer 33 are performed in parallel on the print data that is divided by the predetermined number of parallel processes. More specifically, the reception processor 31 acquires the divided pieces of print data in a parallel process. The print data analyzer 32 performs command-analyzes the divided pieces of print data in a parallel process. Furthermore, the rendering process analyzer 33 rasterizes the divided pieces of print data in a parallel process to generate the raster data.

The parallel process is performed by incorporating a multi-core processor including multiple cores into the CPU 301 (see FIG. 3), and causing each core to perform each parallel process. More specifically, the cores of the multi-core processor may perform arithmetic operations independently of each other. The core responsible for processing a given divided piece of print data is determined, and that core performs a series of processes of the reception processor 31, the print data analyzer 32, and the rendering process analyzer 33. The number of parallel processes are desirably equal to the number of cores of the CPU 301. More specifically, the number of parallel processes may be 2, 4, 8, or the like. The parallel process may be interpreted to mean that the same number of cores as the number of parallel processes in the multi-processor is used, and that each process is performed on the divided print data using the core.

The page sequence controller 35 re-constructs the raster data in a consecutive ascending or descending page order. The page sequence controller 35 functions a concatenating unit configured to concatenate the generated raster data in the consecutive page order.

The display and operation unit 36 corresponds to the operation panel 305 in FIG. 3, and includes a touchpanel or the like. The display and operation unit 36 displays a variety of types of information related to the image forming apparatus 3.

The parallel process count memory 37 stores the number of parallel processes, and transmits the number of parallel processes in response to a poll from the printer driver 23 (see FIG. 4). In this way, the printer driver 23 determines the number by which the print data is divided.

The mechanism controller 38 controls the whole operation of the controller 30a, and also controls the operation of each printing mechanism of the image forming unit 30b.

The operation of the image forming system 1 is described below.

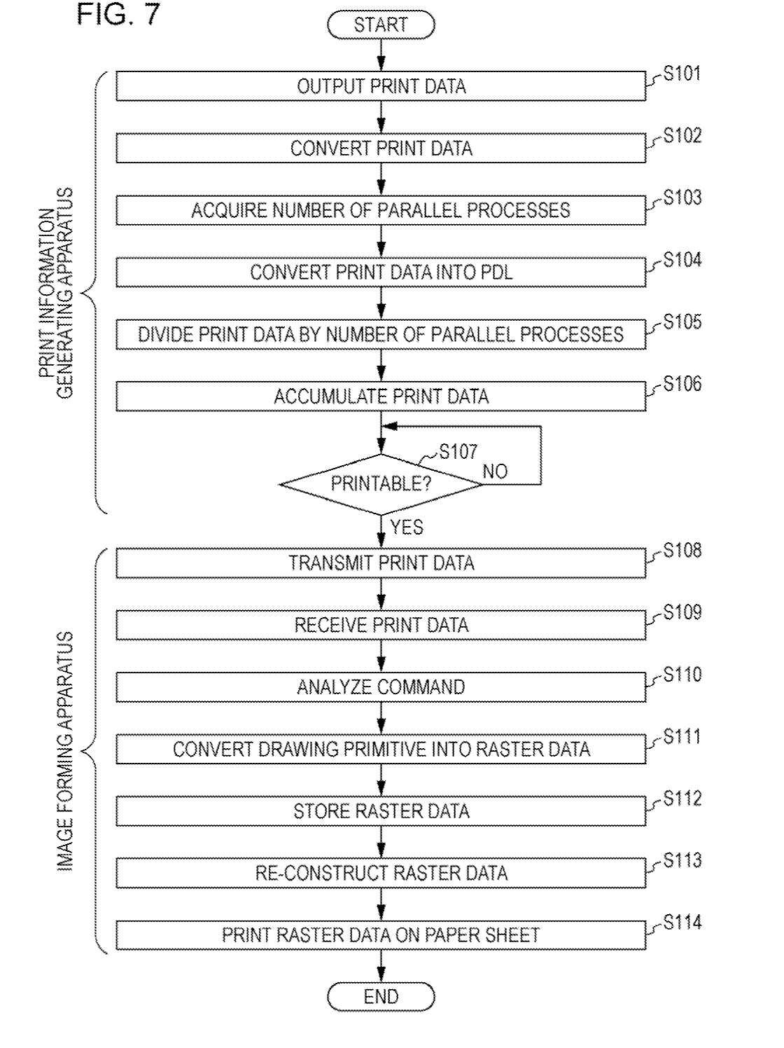

FIG. 7 is a flowchart illustrating an operation of the image forming system 1 of the exemplary embodiment.

The operation of the image forming system 1 is described with reference to FIG. 4 through FIG. 7.

The application program 21 in the print information generating apparatus 2 outputs the print data (step S101).

The rendering engine 22 converts the print data into data in a form processable by the printer driver 23 and transfers the resulting data to the printer driver 23 (step S102).

The printer driver 23 acquires the number of parallel processes from the parallel process count memory 37 in the controller 30a (step S103). The printer driver 23 converts the print data into the PDL data (step S104). The printer driver 23 further divides the PDL data by the number of parallel processes (step S105).

The spooler 24 accumulates the divided print data on the printer data memory 25 (step S106).

The port monitor 26 polls the image forming apparatus 3 to determine whether the image forming apparatus 3 is ready to print the print data. If the image forming apparatus 3 is ready to print the print data (no branch from step S107), processing returns to step S107. If the image forming apparatus 3 is ready to print (yes branch from step S107), the port monitor 26 acquires the divided print data from the printer data memory 25 and transmits the divided print data to the image forming apparatus 3 (step S108). The network communication controller 27 performs control so that the divided pieces of print data are transmitted in parallel.

The reception processor 31 of the controller 30a in the image forming apparatus 3 receives the print data transmitted from the port monitor 26 (step S109).

The print data analyzer 32 command-analyzes the print data and expands the print data into drawing primitives (step S110).

The rendering process analyzer 33 converts the drawing primitives into raster data on a per page basis, resulting in raster image (step S111). The raster image is temporarily stored on the page buffer unit 34 (step S112).

The operations of the reception processor 31, the print data analyzer 32, and the rendering process analyzer 33 are performed in a parallel process on the print data divided by the number of parallel process.

The page sequence controller 35 re-constructs the raster data, thereby concatenating the raster data in ascending or descending consecutive page order (step S113).

The re-constructed raster data is transferred to the image forming unit 30b to be printed on a paper sheet (step S114).

The division method of the print data performed in step S105 is further described.

In some methods, the print data is regularly divided in accordance with the page number.

More specifically, those methods are described with reference to FIG. 5A and FIG. 5B. Referring to FIG. 5A, the page numbers are sequentially allocated to the group 1 through the group 4 on a per page basis. The print data is thus divided by 4. Referring to FIG. 5B, the page numbers are sequentially allocated to the group 1 through the group 4 with two page per group at a time. The print data is thus divided by 4.

In another method, the page numbers are allocated to the groups based on the data size on each page and predetermined rendering evaluation information.

For example, the page numbers are divided based on the data size of each page as described below.

A given page (page 10, for example) may now be allocated to the group 1. The printer driver 23 determines whether the next page (page 11 in this case) is larger than a predetermined threshold value. If the next page is equal to or below the predetermined threshold value, the next page is consecutively allocated to the group 1. If the next page is larger than the predetermined threshold value, the next page is allocated to the group 2 as the next group. The group 2 is followed by the group 3 as the next group, and the group 3 is followed by the group 4 as the next group. The group 4 is followed by the group 1 as the next group.

The threshold value may be 20 Kbytes, for example. For example, the page numbers are divided based on the rendering evaluation information as described below. A threshold value is set on the rendering evaluation information in accordance with a predetermined rule. In a way similar to the data size case described above, it is determined whether the rendering evaluation information is larger than the threshold value and the page number is allocated depending on the determination result.

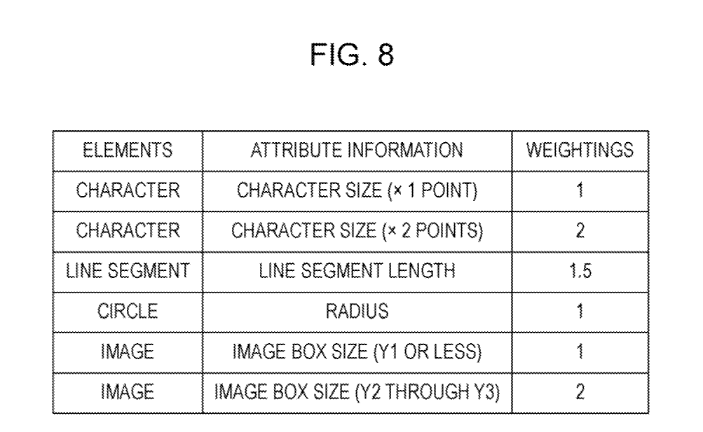

FIG. 8 illustrates the rendering evaluation information to be used in the case described above.

As illustrated in FIG. 8, weightings of elements, such as a character, a line segment, a circle, and an image, contained in the print data are predetermined, and the rendering evaluation information is then determined based on the weightings.

More in detail, since a weighting for a character of X1 point is 1, the rendering evaluation information of 1X1=1 is thus generated for the X1 point character. A weighting for a character of X2 point is 2, and the rendering evaluation information of 1X2=2 is generated for the X2 point character.

As for one line segment, the rendering evaluation information results from multiplying the length of the line segment by a weighting of 1.5. As for one circle, the rendering evaluation information results from multiplying the radius of the circle by a weighting of 1.

As for an image, the size of an image box containing the image is considered. If the image box size is equal to or smaller than Y1, the rendering evaluation information results from multiplying the image box size of the image 1 by a weighting of 1. If the image box size falls within a range from Y2 to Y3, the rendering evaluation information results from multiplying the image box size by a weighting of 2.

The sum of these pieces of rendering evaluation information may be simply compared with a set threshold value on each page. In this case, 1000 may be set for the threshold value.

The data size and the rendering evaluation information are interpreted to mean a load to process each page on each of the reception processor 31, the print data analyzer 32, and the rendering process analyzer 33. By allocating the page numbers as described above, the groups are easily equalized in the overall data size and the size of the rendering evaluation information. As a result, the print data is divided as illustrated in FIG. 5C.

In the image forming system 1 described in detail above, the reception processor 31, the print data analyzer 32, and the rendering process analyzer 33 in the controller 30a acquire the print data, command-analyzes the print data, and generates the raster data in a parallel process. In each of the processes, the processing speed thereof is unlikely to become a bottleneck.

If the CPU 301 (see FIG. 3) includes multi cores with the number of cores equal to the number of parallel processes, the pieces of print data divided by the number of parallel processes are processed by the respective cores. A linear increase in the processing speed depending on the number cores is thus expected.

In the exemplary embodiment, the print data is divided in ascending or descending discrete page order.

The following advantages are provided.

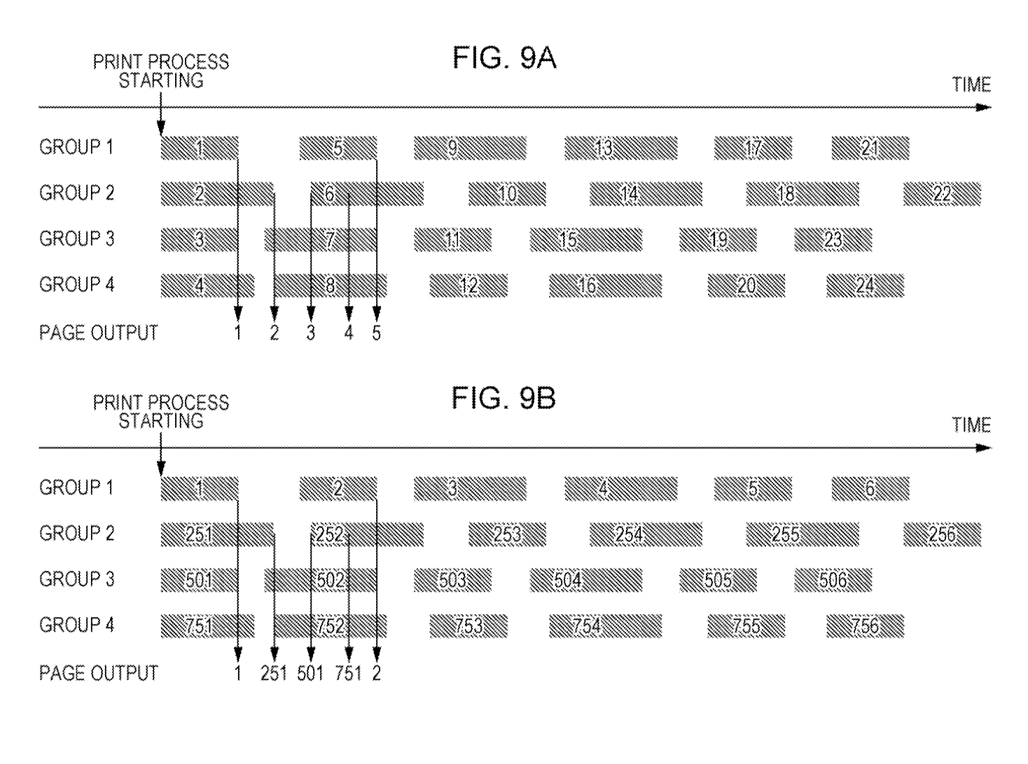

FIG. 9A and FIG. 9B illustrate how differently the raster data is generated depending on whether print data is divided discrete or consecutive order.

FIG. 9A illustrates the print data that is divided into a discrete order, and corresponds to the order described with reference to FIG. 5A. FIG. 9B illustrates the print data that is divided into a consecutive order, and corresponds to the order described with reference to FIG. 5D.

Time until the pages of page numbers contained in the group 1 through the group 4 are rasterized is represented by the length of each horizontal line in FIG. 9A and FIG. 9B. The longer the length of the horizontal line, the longer the process time, and the shorter the length of the horizontal line, the shorter the process time.

The page numbers of each of the first five pages are illustrated at the bottom row of each of FIG. 9A and FIG. 9B.

FIG. 9A illustrates that page 1 through page 5 are output in that order. More specifically, the page output is performed in the page order of 1, 2, 3, 4, and then 5.

FIG. 9B illustrates that page numbers are output in the page order of 1, 251, 501, 751, and then 2.

The output raster data is transferred to the image forming unit 30b generally in the page order as illustrated in FIG. 9A. The image forming unit 30b may thus print the raster data as is.

Referring to FIG. 9B, the raster data of page 251, page 501, and page 751 is transferred, and there is no corresponding preceding raster data available. The image forming unit 30b is unable to print these pieces of rater data. As a result, the image forming unit 30b waits for raster data of two pages, with waiting time occurring as a result.

The image forming unit 30b prints at a higher speed when the print data is divided into a discrete order than when the print data is divided into a consecutive order.

The page numbers are allocated in accordance with the data size or the rendering evaluation information, and the groups are generally equalized with ease in terms of the overall data size or the size of the rendering evaluation information. In such a case, the total process times to rasterize the data are generally equalized with ease from group to group. More specifically, loads are more uniformly distributed among the groups.

If the process time is different from group to group, the total process time before completing the rasterization of one print job is the time of a group that has taken the longest time after all. The longer the total process time, the longer the waiting time of the image forming unit 30b. As a difference in the process time from group to group is larger, the overall print speed tends to decrease more. If the loads are more uniformly distributed among the groups, the overall print speed is more likely to increase.

In the example described above, the parallel process count memory 37 is employed, and the printer driver 23 acquires the number of parallel processes from the parallel process count memory 37 in the controller 30a. The present invention is not limited to this arrangement. For example, a device type memory configured to store a device type of or a serial number of the image forming apparatus 3 may be used in place of the parallel process count memory 37. The printer driver 23 may retrieve from the device type memory the device type of or the serial number of the image forming apparatus 3, and may then determine the number of parallel processes.

The process performed by the print information generating apparatus 2 or the controller 30a in the exemplary embodiment described above may be implemented when a software resource and a hardware resource cooperate with each other.

For example, the process of the print information generating apparatus 2 is performed when the CPU 201 in the print information generating apparatus 2 loads a program, such as an application program implementing each function of the print information generating apparatus 2, from the HDD 203 to the memory 202 and then executes the program.

The process of the print information generating apparatus 2 may be interpreted as a program. The program causes a computer to execute a print information acquisition function that acquires a plurality of pieces of print information of each print job to be performed on the image forming unit 30b configured to form an image on a recording material, with the plurality of pieces of print information divided by a predetermined number of parallel processes and arranged in ascending or descending discrete page order, a command analyzing function that command-analyzes the acquired print information,

a rasterizing function that rasterizes the command-analyzed print information to generate raster data, and a
concatenating unit that concatinates the generated raster data in a consecutive page order. The print information acquisition function, the command analyzing function, and the rasterizing function are performed in parallel on the print information.

The process of the controller 30a is performed when the CPU 301 in the controller 30a loads a program, such as an application program implementing each function of the controller 30a, from the ROM 303 to the RAM 302 and then executes the program.

The process of the controller 30a may be interpreted as a program. The program causes a computer to implement a print information generating function that generates a plurality of pieces of print information of each print job to be performed on the image forming apparatus 3 configured to form an image on a recording material, with the plurality of pieces of print information divided by a predetermined number of parallel processes equal to a number of parallel processes executable by the image forming apparatus 3 and arranged in ascending or descending discrete page order, and a transmitting function that transmits the plurality of pieces of generated print information in parallel to the image forming apparatus 3.

The program implementing the exemplary embodiment is provided not only via communications, but also via a recording medium, such as a compact disk read-only memory (CD-ROM) having the program recorded thereon.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a print information acquisition unit that acquires a plurality of pieces of print information of each print job to be performed on an image forming unit configured to form an image on a recording material, the plurality of pieces of print information divided by a predetermined number of parallel processes and arranged in ascending or descending discrete page order;
a command analyzing unit that command-analyzes the acquired print information;
a rasterizing unit that rasterizes the command-analyzed print information to generate raster data; and
a concatenating unit that concatinates the generated raster data in a consecutive page order,
wherein the print image acquisition unit, the command analyzing unit, and the rasterizing unit perform parallel processes thereof on the print information.

2. The image processing apparatus according to claim 1, wherein the print information is generated so that durations of time consumed from an operation of the print information acquisition unit to acquire the print information to an operation of the rasterizing unit to generate the raster data based on the print information are equalized.

3. The image processing apparatus according to claim 1, wherein the parallel process is executed by using cores of a number equal to the number of parallel processes in a multi-core processor, and the cores are used respectively for divided pieces of print information.

4. The image processing apparatus according to claim 2, wherein the parallel process is executed by using cores of a number equal to the number of parallel processes in a multi-core processor, and the cores are used respectively for divided pieces of print information.

5. The image processing apparatus according to claim 1, wherein the print information is allocated to each page depending on whether a data size of the page forming the print information is larger than a predetermined threshold value or not so that the print information is divided by the predetermined number of parallel processes.

6. The image processing apparatus according claim 2, wherein the print information is allocated to each page depending on whether a data size of the page forming the print information is larger than a predetermined threshold value or not so that the print information is divided by the predetermined number of parallel processes.

7. The image processing apparatus according to claim 3, wherein the print information is allocated to each page depending on whether a data size of the page forming the print information is larger than a predetermined threshold value or not so that the print information is divided by the predetermined number of parallel processes.

8. The image processing apparatus according to claim 4, wherein the print information is allocated to each page depending on whether a data size of the page forming the print information is larger than a predetermined threshold value or not so that the print information is divided by the predetermined number of parallel processes.

9. The image processing apparatus according to claim 1, wherein the print information is allocated to each page depending on whether rendering evaluation information generated based on a weight predetermined for each element included in the print information is larger than a predetermined threshold value or not so that the print information is divided by the predetermined number of parallel processes.

10. The image processing apparatus according to claim 2, wherein the print information is allocated to each page depending on whether rendering evaluation information generated based on a weight predetermined for each element included in the print information is larger than a predetermined threshold value or not so that the print information is divided by the predetermined number of parallel processes.

11. The image processing apparatus according to claim 3, wherein the print information is allocated to each page depending on whether rendering evaluation information generated based on a weight predetermined for each element included in the print information is larger than a predetermined threshold value or not so that the print information is divided by the predetermined number of parallel processes.

12. The image processing apparatus according to claim 4, wherein the print information is allocated to each page depending on whether rendering evaluation information generated based on a weight predetermined for each element included in the print information is larger than a predetermined threshold value or not so that the print information is divided by the predetermined number of parallel processes.

13. A print information generating apparatus, comprising:
a print information generating unit that generates a plurality of pieces of print information of each print job to be performed on an image forming apparatus configured to form an image on a recording material, the plurality of pieces of print information divided by a predetermined number of parallel processes equal to a number of parallel processes executable by the image forming apparatus and arranged in ascending or descending discrete page order; and
a transmitting unit that transmits the plurality of pieces of generated print information in parallel to the image forming apparatus.

14. The print information generating apparatus according to claim 13, wherein the print information generating unit generates the print information so that durations of time consumed from an operation of the image forming apparatus to acquire the print information to an operation of the rasterizing unit to generate the raster data based on the print information are equalized.

15. An image forming apparatus comprising:
an image forming unit that forms an image on a recording material; and
an image processor that generates raster data for use in the image forming unit, wherein the image processor includes:
a print information acquisition unit that acquires a plurality of pieces of print information of each print job to be performed on the image forming unit, the plurality of pieces of print information divided by a predetermined number of parallel processes and arranged in ascending or descending discrete page order;
a command analyzing unit that command-analyzes the acquired print information;
a rasterizing unit that rasterizes the command-analyzed print information to generate raster data; and
a concatenating unit that concatinates the generated raster data in a consecutive page order,
wherein the print image acquisition unit, the command analyzing unit, and the rasterizing unit perform parallel processes thereof on the print information.

16. An image forming system comprising:
a print information generating apparatus that generates print information; and
an image forming apparatus that includes an image forming unit configured to form an image on a recording material and an image processor configured to generate raster data for use in the image forming unit,
wherein the image processor in the image forming apparatus includes:
a print information acquisition unit that acquires a plurality of pieces of print information of each print job to be performed on the image forming unit, the plurality of pieces of print information divided by a predetermined number of parallel processes and arranged in ascending or descending discrete page order;
a command analyzing unit that command-analyzes the acquired print information;
a rasterizing unit that rasterizes the command-analyzed print information to generate raster data; and
a concatenating unit that concatinates the generated raster data in a consecutive page order,
wherein the print image acquisition unit, the command analyzing unit, and the rasterizing unit perform parallel processes thereof on the print information.

17. An image processing method comprising:
acquiring a plurality of pieces of print information of each print job to be performed on an image forming unit configured to form an image on a recording material, the plurality of pieces of print information divided by a predetermined number of parallel processes and arranged in ascending or descending discrete page order;
command-analyzing the acquired print information;
rasterizing the command-analyzed print information to generate raster data; and
concatenating the generated raster data in a consecutive page order,
wherein the acquiring, the command-analyzing, and the rasterizing are performed in parallel on the print information.

18. A print information generating method, comprising:
generating a plurality of pieces of print information of each print job to be performed on an image forming apparatus configured to form an image on a recording material, the plurality of pieces of print information divided by a predetermined number of parallel processes equal to a number of parallel processes executable by the image forming apparatus and arranged in ascending or descending discrete page order; and
transmitting the plurality of pieces of generated print information in parallel to the image forming apparatus.

19. A non-transitory computer readable medium storing a program causing a computer to execute a process for processing an image, the process comprising:
acquiring a plurality of pieces of print information of each print job to be performed on an image forming unit configured to form an image on a recording material, the plurality of pieces of print information divided by a predetermined number of parallel processes and arranged in ascending or descending discrete page order;
command-analyzing the acquired print information;
rasterizing the command-analyzed print information to generate raster data; and
concatenating the generated raster data in a consecutive page order,
wherein the acquiring, the command-analyzing, and the rasterizing are performed in parallel on the print information.

20. A non-transitory computer readable medium storing a program causing a computer to execute a process for generating print information, the process comprising:
generating a plurality of pieces of print information of each print job to be performed on an image forming apparatus configured to form an image on a recording material, the plurality of pieces of print information divided by a predetermined number of parallel processes equal to a number of parallel processes executable by the image forming apparatus and arranged in ascending or descending discrete page order; and
transmitting the plurality of pieces generated print information in parallel to the image forming apparatus.
